(19) United States
(12) Patent Application Publication
(10) Pub. No.: US 2013/0107185 A1
(43) Pub. Date: May 2, 2013

(54) ELECTRODE PATTERN, PIXEL LAYOUT METHOD, AND LIQUID CRYSTAL DISPLAY

(71) Applicants: INNOCOM TECHNOLOGY(SHENZHEN) CO., LTD., Shenzhen City (CN); CHIMEI INNOLUX CORPORATION, Chu-Nan (TW)

(72) Inventors: Chien-Hung CHEN, Chu-Nan (TW); Wei-Jean LIU, Chu-Nan (TW); Jia-Lun CHEN, Chu-Nan (TW)

(73) Assignees: CHIMEI INNOLUX CORPORATION, Chu-Nan (TW); INNOCOM TECHNOLOGY(SHENZHEN) CO., LTD., Shenzhen City (CN)

(21) Appl. No.: 13/661,464

(22) Filed: Oct. 26, 2012

(30) Foreign Application Priority Data
Oct. 27, 2011 (TW) 100139052

(51) Int. Cl. G02F 1/1343; H05B 33/10

(52) U.S. Cl. 349/142; 427/66

(57) ABSTRACT

The invention provides an electrode pattern formed on at least one of a first substrate and a second substrate in a liquid crystal display, including: a plurality of main slits including a first main slit and a second main slit crossing the first main slit; and a plurality of sub slits, wherein each sub slit is connected to one of the first main slit and the second main slit at an end. The width of the first main slit and the second main slit increases in size toward the intersection of the first main slit and the second main slit.

### CROSS REFERENCE TO RELATED APPLICATIONS

This Application claims priority of Taiwan Patent Application No. 100139052, filed on Oct. 27, 2011, the entirety of which is incorporated by reference herein.

### BACKGROUND OF THE INVENTION

1. Field of the Invention

The present invention relates to an electrode pattern, a pixel layout method, and a liquid crystal display, and in particular relates to an electrode pattern and a pixel layout method capable of accelerating response speed of liquid crystal molecules in a liquid crystal layer of a liquid crystal display.

2. Description of the Related Art

In a liquid crystal display, if two polarizers that are oriented at 90° to one another are used, it is desired that liquid crystal molecules in a liquid crystal layer between the two polarizers rotate to appropriate angles when they align in the plane of the liquid crystal layer, to obtain a maximum transmittance in the bright state. For example, if the two polarizers are oriented at 0° and 90°, respectively, the liquid crystal molecules are desired to rotate to 45° or 135° in the bright state to achieve the maximum transmittance. Here, in order to rotate the liquid crystal molecules to predetermined angles by applying an electric field, a pixel layout method using a predetermined electrode pattern to control the rotating angles of the liquid crystal molecules is used.

If such patterned electrodes are used to control the orientation layout of the liquid crystal molecules, the liquid crystal molecules are expected to rotate to predetermined angles as fast as possible for the maximum transmittance in the bright state. However, response speed of the liquid crystal molecules is influenced by the resultant electric field provided by the pattern electrodes. Therefore, raising response speed of liquid crystal molecules by a well designed electrode pattern is desired.

### BRIEF SUMMARY OF THE INVENTION

A detailed description is given in the following embodiments with reference to the accompanying drawings.

The invention provides an electrode pattern applied to at least one of an upper substrate and a lower substrate in a liquid crystal display, including a plurality of main slits comprising a first main slit and a second main slit crossing the first main slit; and a plurality of sub slits, wherein each sub slit is connected to one of the first main slit and the second main slit at an end. The width of the first main slit and the second main slit increases in size toward the intersection of the first main slit and the second main slit.

In an embodiment of the invention, the width of the first main slit and the second main slit varies linearly

In an embodiment of the invention, when viewing is performed along the first main slit or the second main slit, the angle between the axis of the first main slit or the second main slit and the line parallel with the edge of the first main slit or the second main slit is at most 10°.

In an embodiment of the invention, when viewing is performed along the first main slit or the second main slit, the angle between the axis of the first main slit or the second main slit and the line parallel with the edge of the first main slit or the second main slit is at least 1°.

In an embodiment of the invention, the electrode pattern is applied to both inner planes of the upper substrate and the lower substrate, wherein a plurality of the electrode patterns forms an array on each inner plane. The array formed by the plurality of electrode patterns on the inner plane of the upper substrate faces to the array formed by the plurality of electrode patterns on the inner plane of the lower substrate in a staggered manner, such that when viewing is performed along the direction perpendicular to the upper substrate and the lower substrate, each electrode pattern is surrounded by the electrode patterns of the opposite substrate.

In an embodiment of the invention, four quadrants are divided by the first main slit and the second main slit, and the other ends of the plurality of sub slits extending in any one of the four quadrants are aligned in a line. The shortest sub slit is closest to the thinnest portion of the first main slit and the second main slit.

In an embodiment of the invention, the plurality of sub slits extend toward the directions of 45°, 135°, 225°, and 315°, in the first to the fourth quadrant of the four quadrants, respectively.

In an embodiment of the invention, the electrode pattern is the portion dug out from a transparent electrode layer.

In addition, the invention provides a pixel layout method for accelerating response speed of liquid crystal molecules in a liquid crystal layer of a liquid crystal display, comprising forming the electrode pattern as claimed in claim 1 on an electrode layer of the liquid crystal display.

The invention also provides a liquid crystal display including: an upper layer; a lower layer; a liquid crystal layer sandwiched between the upper layer and the second layer; and an electrode pattern applied to at least one of the upper layer and the lower layer. The electrode pattern comprises a plurality of main slits comprising a first main slit and a second main slit crossing the first main slit; and a plurality of sub slits, wherein each sub slit connected to one of the first main slit and the second main slit at an end. The width of the first main slit and the second main slit increases in size toward the intersection of the first main slit and the second main slit.

### BRIEF DESCRIPTION OF THE DRAWINGS

The present invention can be more fully understood by reading the subsequent detailed description and examples with references made to the accompanying drawings, wherein:

FIG. 1a is top view of an electrode pattern of an upper substrate in accordance with an embodiment of the invention.

FIG. 1b is top view of an electrode pattern of a lower substrate in accordance with an embodiment of the invention.

FIG. 2 is a top view of the overlapping area of the electrode pattern 10 of the upper substrate of FIG. 1a and the electrode pattern 20 of the lower substrate of FIG. 1b.

FIG. 3 is a diagram showing the influence of different tangential angles to the response speed of a liquid crystal display using the electrode pattern shown in FIG. 2.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

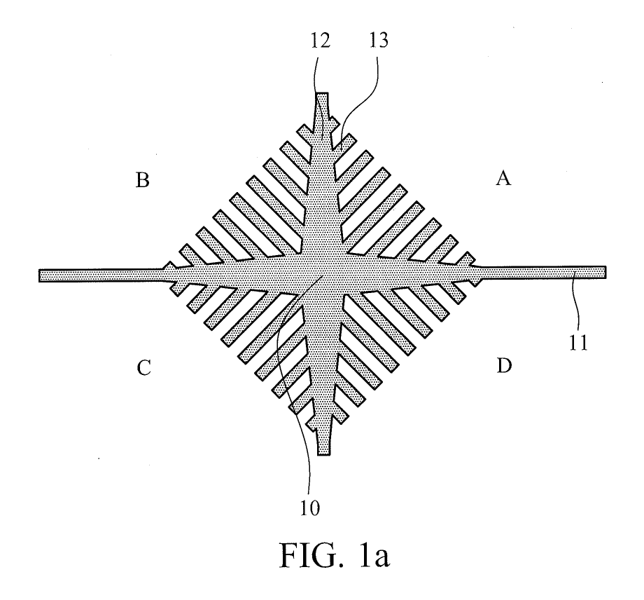

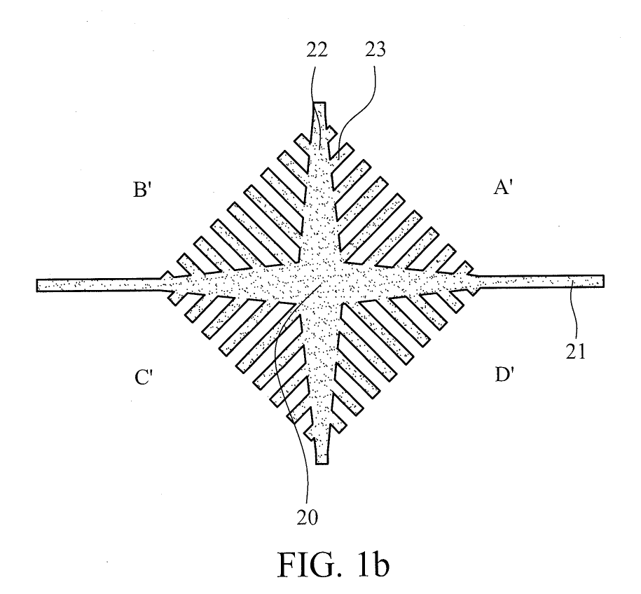

FIG. 1a is top view of an electrode pattern of an upper substrate in accordance with an embodiment of the invention. FIG. 1b is top view of an electrode pattern of a lower substrate in accordance with an embodiment of the invention.

FIG. 1a shows an electrode pattern 10 of the upper substrate (the side where the color filter is disposed). The electrode pattern 10 is the portion dug out from a transparent electrode layer of the upper substrate.

The electrode pattern 10 comprises a pair of main slits 11 and 12 perpendicular to each other and a plurality of sub slits 13. The width of the main slits 11 and 12 is not constant, which increases in size toward the intersection of the main slits 11 and 12. As shown in FIG. 1a, the main slits 11 and 12 forms a shuriken shape.

For simplicity, 4 domains divided by the main slits 11 and 12 of the electrode pattern 10 of FIG. 1a are defined as 4 quadrants A˜D. In the 1st quadrant A, the plurality of sub sits 13 of the electrode pattern 10 extend from the main slits 11 and 12 toward the direction of 45°. In the 2nd quadrant B, the plurality of sub sits 13 extend toward the direction of 135°. In the 3rd quadrant C, the plurality of sub sits 13 extend toward the direction of 225°. In the 4th quadrant D, the plurality of sub sits 13 extend toward the direction of 315°.

FIG. 1b shows an electrode pattern 20 of the lower substrate (the side where thin film transistors are disposed). The electrode pattern 20 is the portion dug out from a transparent electrode layer of the lower substrate.

The electrode pattern 20 comprises a pair of main slits 21 and 22 perpendicular to each other and a plurality of sub slits 23. The width of the main slits 21 and 22 is not constant, which increases in size toward the intersection of the main slits 21 and 22. As shown in FIG. 1b, the main slits 21 and 22 form a shuriken shape.

Similarly, 4 domains divided by the main slits 21 and 22 of the electrode pattern 20 of FIG. 1b are defined as 4 quadrants A′˜D′. In the 1st quadrant A′, the plurality of sub sits 23 of the electrode pattern 20 extend from the main slits 21 and 22 toward the direction of 45°. In the 2nd quadrant B′, the plurality of sub sits 23 extend toward the direction of 135°. In the 3rd quadrant C′, the plurality of sub sits 23 extend toward the direction of 225°. In the 4th quadrant D′, the plurality of sub sits 23 extend toward the direction of 315°.

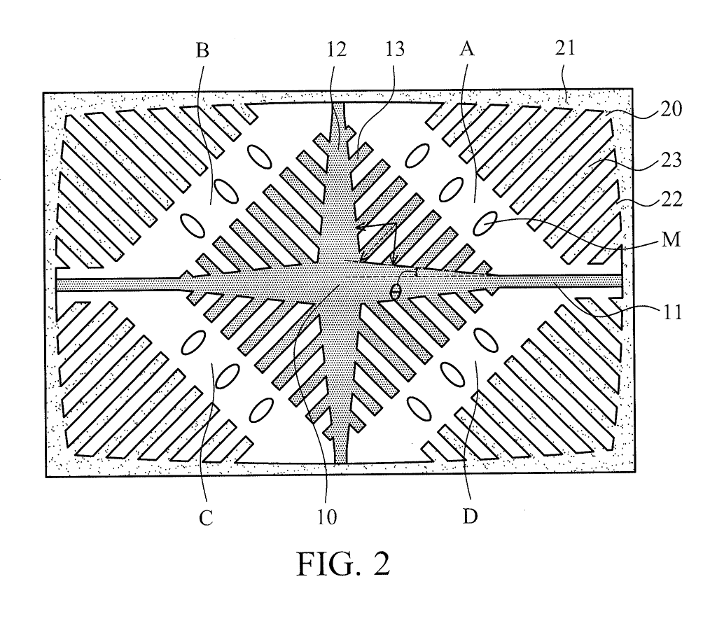

FIG. 2 is a top view of the overlapping area of the electrode pattern 10 of the upper substrate of FIG. 1a and the electrode pattern 20 of the lower substrate of FIG. 1b.

FIG. 2 shows both the electrode pattern 10 of the upper substrate (the side where the color filter is disposed) and the electrode pattern 20 of the lower substrate (the side where thin film transistors are disposed), wherein an array formed by a plurality of electrode patterns 10 faces to an array formed by a plurality of electrode patterns 20 in a staggered manner. Specifically, when viewing is performed along the direction perpendicular to the panel, each electrode pattern 10 is surrounded by 4 electrode patterns 20 from its 4 quadrants and each electrode pattern 20 is also surrounded by 4 electrode patterns 10 from its 4 quadrants. Note that the block shown in FIG. 2 is merely a minimum unit of an electrode pattern, comprising one electrode pattern 10 of the upper substrate and four ¼-portions of the electrode pattern 20 (equal to one electrode pattern 20) of the upper substrate. Depending on design, the electrode pattern shown in FIG. 2 can correspond to a pixel, a sub-pixel, or a portion of a sub-pixel. A plurality of the electrode patterns shown in FIG. 2 are arranged to form a complete electrode pattern for a panel.

According to the electrode pattern of the embodiment, when voltage is applied to electrodes, liquid crystal molecules M in the 1st quadrant A rotate to the direction of 45° (225°) because of electric field forces due to the sub slits 13 and 23. However, in addition to the electric field forces due to the sub slits 13 and 23, the main slits 11, 12, 21, and 22 also provide electric field forces to rotate the liquid crystal molecules M in the 1st quadrant A to the direction of 45° (225°). For example, as shown by the solid arrows in FIG. 2, the main slits 11 and 12 provide two pulling forces perpendicular to the edges of the main slits 11 and 12, respectively. The resultant force is shown by the dotted arrow, which acts in the direction of 225°.

Similarly, when voltage is applied to electrodes, liquid crystal molecules M in the 2nd quadrant B rotate to the direction of 135° (315°), liquid crystal molecules M in the 3rd quadrant C rotate to the direction of 225° (45°), and liquid crystal molecules M in the 4th quadrant D rotate to the direction of 315° (135°).

In the 1st quadrant A, as shown by the solid arrows, the two pulling forces perpendicular to the edges of the main slits 11 and 12 deviate from the directions of 90° and 0°, respectively. This deviation angle equals to a tangential angle θ which is defined by an angle between the edge of the main slits 11 and the axis of 0° or between the main slits 12 and the axis of 90°. Though the two forces provided by the main slits 11 and 12 deviate from the directions of 90 ° and 0 ° respectively, the resultant force of the two forces still acts in the direction of 225°.

Therefore, the directions of the electric field forces due to the main slits 11 and 12 are biased toward the predetermined rotating direction for the liquid crystal molecules M, such that the liquid crystal molecules M can rotate to the predetermined rotating direction in a short time. Namely, the liquid crystal molecules M rotate to the direction of 45° (225°) in the 1st quadrant A, the direction of 135° (315°) in the 2nd quadrant B, the direction of 225° (45°) in the 3rd quadrant C, and the direction of 315° (135°) in the 4th quadrant D.

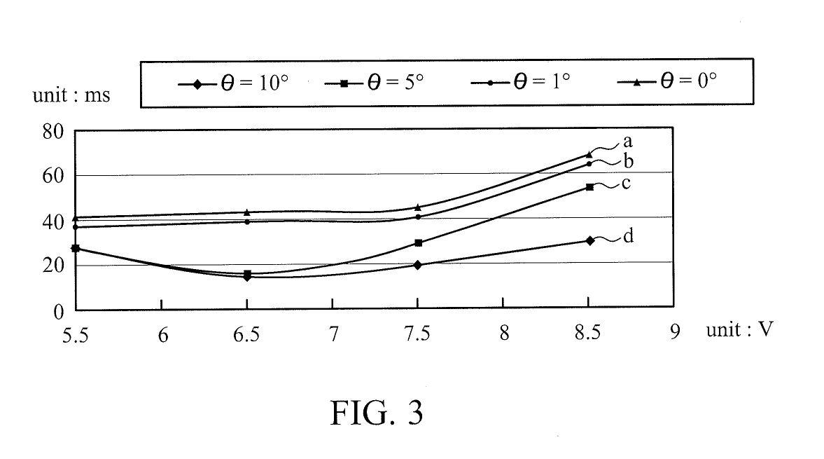

FIG. 3 is a diagram showing the influence of different tangential angles θ to the response speed of a liquid crystal display using the electrode pattern shown in FIG. 2. In FIG. 3, the horizontal axis represents a driving voltage and the vertical axis represents a response time. FIG. 3 shows curves a, b, c, and d respectively depicted in the case where the tangential angles θ is 0°, 1°, 5°, and 10°. It is understood that at a predetermined driving voltage, the curve a, which is depicted in the case where the tangential angles θ is 0°, has the longest response time, and the curve d, which is depicted in the case where the tangential angles θ is 10°, has a shorter response time than the response time of the curves b and c, which are depicted in the case where the tangential angles θ is 1° and 5° respectively.

According to the above, the embodiment of the invention can substantially raise response speed of pixels switching from the dark state to the bright state. The response speed of the liquid crystal molecules increases as the tangential angle of the main slits of the pixel pattern increases. Therefore, in an embodiment of the invention, at least 1° for the tangential angle is preferred. However, large tangential angles cause a decrease of transmittance. For example, the transmittance in the case where the tangential angle is 10° is 86.61% of that in the case where the tangential angle is 0°. In this regard, in an embodiment of the invention, at most 10° for the tangential angle is preferred.

By adopting the electrode pattern according to the embodiment of the invention, a liquid crystal display can switch from the dark state to the bright state in a short time. Therefore, the invention can substantially raise the response speed of the liquid crystal display.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). For example, the tangential angle structure can be applied to the main slits in only one guardant. The electrode pattern with the tangential angle structure can be applied to only one of the upper substrate and the lower substrate. Furthermore, it is not limited that the width of the two main slits increases in size linearly toward the intersection of the two main slits. The edge of the two main slits can be curved or jagged to increase the width of the two main slits toward the intersection of the two main slits. Therefore, the scope of the appended claims should be accorded the broadest interpretation so as to encompass all such modifications and similar arrangements.

What is claimed is:

1. An electrode pattern applied to at least one of an upper substrate and a lower substrate in a liquid crystal display, comprising a plurality of main slits comprising a first main slit and a second main slit crossing the first main slit; and
a plurality of sub slits, wherein each sub slit is connected to one of the first main slit and the second main slit at an end,
wherein the width of the first main slit and the second main slit increases in size toward the intersection of the first main slit and the second main slit.

2. The electrode pattern as claimed in claim 1, wherein the width of the first main slit and the second main slit varies linearly.

3. The electrode pattern as claimed in claim 2, wherein when viewing is performed along the first main slit or the second main slit, the angle between the axis of the first main slit or the second main slit and the line parallel with the edge of the first main slit or the second main slit is at most 10°.

4. The electrode pattern as claimed in claim 2, wherein when viewing is performed along the first main slit or the second main slit, the angle between the axis of the first main slit or the second main slit and the line parallel with the edge of the first main slit or the second main slit is at least 1°.

5. The electrode pattern as claimed in claim 3, wherein:
the electrode pattern is applied to both inner planes of the upper substrate and the lower substrate, wherein a plurality of the electrode patterns forms an array on each inner plane, and
the array formed by the plurality of electrode patterns on the inner plane of the upper substrate faces to the array formed by the plurality of electrode patterns on the inner plane of the lower substrate in a staggered manner, such that when viewing is performed along the direction perpendicular to the upper substrate and the lower substrate, each electrode pattern is surrounded by the electrode patterns of the opposite substrate.

6. The electrode pattern as claimed in claim 1, wherein:
four quadrants are divided by the first main slit and the second main slit, and the other ends of the plurality of sub slits extending in any one of the four quadrants are aligned in a line; and
the shortest sub slit is closest to the thinnest portion of the first main slit and the second main slit.

7. The electrode pattern as claimed in claim 6, wherein the plurality of sub slits extend toward the directions of 45°, 135°, 225°, and 315°, in the first to the fourth quadrant of the four quadrants, respectively.

8. The electrode pattern as claimed in claim 1, wherein the electrode pattern is the portion dug out from a transparent electrode layer.

9. A pixel layout method for accelerating response speed of liquid crystal molecules in a liquid crystal layer of a liquid crystal display, comprising:
forming the electrode pattern as claimed in claim 1 on an electrode layer of the liquid crystal display.

10. A liquid crystal display, comprising:
an upper layer;
a lower layer;
a liquid crystal layer sandwiched between the upper layer and the second layer; and
an electrode pattern applied to at least one of the upper layer and the lower layer, comprising:
a plurality of main slits comprising a first main slit and a second main slit crossing the first main slit; and
a plurality of sub slits, wherein each sub slit is connected to one of the first main slit and the second main slit at an end,
wherein the width of the first main slit and the second main slit increases in size toward the intersection of the first main slit and the second main slit.
